(19) United States
(12) Patent Application Publication
(10) Pub. No.: US 2022/0410433 A1
(43) Pub. Date: Dec. 29, 2022

(54) MOBILE CART COMBINING ELECTRICAL POWER GENERATION AND DUST COLLECTION

(71) Applicant: Refuse Materials, Inc., Ocilla, GA (US)

(72) Inventor: Donald A. Pope, JR., Ocilla, GA (US)

(21) Appl. No.: 17/749,527

(22) Filed: May 20, 2022

Related U.S. Application Data
(60) Provisional application No. 63/216,324, filed on Jun. 29, 2021.

(51) Int. Cl. B28D 7/02; B28D 1/00; B24B 1/00

(52) U.S. Cl. CPC B28D 7/02; B28D 1/003; B24B 1/00

(57) ABSTRACT

A combination cart providing independent electrical power generation and dust extraction capabilities finds utility in concrete processing and other operations that create unwanted dust using hand tools for cutting, grinding, polishing, coring, drilling, sanding, and the like. A propane tank powers a propane engine, and the propane engine drives an electrical generator providing power to an electrical outlet panel mounted on the frame. The cart further includes a dust extraction and filtration system driven by an electric motor, also mounted on the frame. The inventive cart facilitates multiple modes of operation, including: (a) dust extraction and filtration only, with the dust extraction system being powered by an available external source of electrical power; (b) electrical power generation only, with the dust extraction and filtration system being turned off; and (c) simultaneous dust extraction/filtration and electrical power generation, with the dust extraction and filtration system being powered by the electrical generator.

### REFERENCE TO RELATED APPLICATIONS

This application claims priority to and the benefit of U.S. Provisional Patent Application Ser. No. 63/216,324, filed Jun. 29, 2021 the entire content of which is incorporated herein by reference.

### FIELD OF THE INVENTION

This invention relates generally to dust collection and, in particular, to a mobile cart combining electrical power generation and dust collection and filtration applicable to concrete processing and other operations.

### BACKGROUND OF THE INVENTION

Polished concrete floors are becoming increasingly popular for retailers, big-box stores, educational and medical facilities, and even residential applications. Common uses include warehouses and warehouse outlets, hotels and restaurants, office buildings and showrooms. Benefits include low cost, resistance to wear, low maintenance, and aesthetic appeal in many situations. Polished concrete floors are easy to clean, and the glossy surface of polished concrete resists the marks of forklift truck tires and staining from oil and chemical spills. The glossy appearance of polished concrete is desirable for office building, hotels, restaurants, and other public facilities that want to project a bright, clean, professional image.

Various different types of machines are used to achieve a polished concrete floor, including riding and walk-behind coarse and fine grinders and polishers using wet and dry techniques. Machines are also available for stripping and removing old floors, filling in cracks, applying concrete overlays, as well as slurry and dust collection.

The polishing process itself proceeds through a series of mechanical and grinding stages utilizing professional equipment designed for these purposes. The process may also include the use of a concrete “densifier” which penetrates into the concrete to harden and dustproof the surface. The concrete surface is processed through a series of steps with grinding and polishing disks having progressively finer grits. The disks are typically fabricated with industrial diamonds in a bonded material such as metal, resin or a combination thereof, often referred to as “diamond polishing pads.”

Typically the concrete goes through a process of grinding and polishing using aggressive equipment and abrasive elements or tooling, including pads of varying grit from 30 to 3,000. Concrete is considered “polished” until grits of 800 or finer are used, followed by finishing to 1500 3000-grit levels. The concrete may be ground without entering aggregate layers, or different sizes of aggregate may be exposed and polished to achieve different appearances. Dyes designed for concrete polishing are often applied to add color to polished concrete for borders, logos and decorative patterns. Such options provide a wide range of surface finish and color variations.

Concrete grinding and polishing begins with grinding pads or tools that have grits of 30, 70, and 120, which are used successively. These abrasive elements are rotated at a relatively slow speed during the grinding steps, e.g., at rotating speeds in the range of about 500 to 800 rpm. After grinding with the diamond pads, honing steps follow using grits of 50, 100, and 200, rotated at, for example, a speed of about 800 rpm. After about 200-grit honing step, dies or stains may be applied and, if necessary, a concrete densifier may be applied to the floor.

Polishing continues using a 400 grit or finer pad, with rotational speeds of the spindles and abrasive elements being in the range of about 800 to 1,100 rpm. The concrete will begin to develop a sheen, with the grit choice of the final polishing steps being dependent upon the reflection and shine desired. If the polishing process is continued through use of a 3000-grit pad, the concrete will assume a mirror-like finish. Burnishing may further promote a specular appearance. A topical sealer may be optionally applied to the finished floor.

The grinding and polishing steps may be dry or wet. With the latter, a water tank on-board the grinding/polishing machine delivers water to the diamond pads or resin pads through channels to the polishing head. With wet polishing, the generated slurry is collected with a squeegee, and with dry polishing the dust is collected with a vacuum. Typically, the polishing head is enclosed with a shroud that surrounds the rotating pads. A vacuum port is connected with a hose to an externally-provided vacuum, which may be nearby or wheeled alongside the grinding and polishing machine.

Although wet and dry techniques both have advantages and disadvantages, dry polishing tends to be faster, more convenient, and environmentally friendly. Wet polishing uses water to cool the diamond abrasives and eliminate grinding dust. The water acts as a lubricant to reduce friction, but cleanup is more involved. Wet polishing creates a tremendous amount of slurry that crews must collect and dispose of in an environmentally sound manner. With dry polishing, no water is required. Instead, the floor polisher is hooked up to a dust-containment system that vacuums up the mess.

In summary, the process of concrete floor polishing may include some or all of the following steps:
Remove existing coating(s);
Deposit new layer of concrete onto uneven or damaged floor,
Seal cracks, joints or imperfections with an epoxy or other semi-rigid filler;
Progressively grind with a 30/40-, 80- and 150-grit metal-bonded diamond pads;
Optionally apply a chemical hardener to densify the concrete;
Progressively polish with a 100/200-, 400- and 800-grit resin or metal-bonded diamond pads;
Apply optional dye(s) for coloration;
Finish with a 1500- or 3000-grit resin-bonded diamond pads to achieve a desired sheen level; and
Optionally seal to help protect the polished surface and make it easier to maintain.

### SUMMARY OF THE INVENTION

This invention improves upon the existing art by providing a combination cart with independent electrical power generation and dust extraction capabilities. The invention finds utility in concrete processing and other operations that create unwanted dust using hand tools for cutting, grinding, polishing, coring, drilling, sanding, and so forth.

The invention resides in a walk-behind mobile frame with a handle and wheels. A propane tank powers a propane engine, and the propane engine drives an electrical generator providing power to an electrical outlet panel mounted on the frame. The cart further includes a dust extraction and filtration system driven by an electric motor mounted on the frame. Given this combination of components, the inventive cart facilitates multiple modes of operation, including:

(a) dust extraction and filtration only, with the dust extraction system being powered by an available external source of electrical power;

(b) electrical power generation only, with the dust extraction and filtration system being turned off; and

(c) simultaneous dust extraction/filtration and electrical power generation, with the dust extraction and filtration system being powered by the electrical generator. In this mode, the electric motor driving the dust extraction and filtration system may be plugged directly into the electrical panel.

In the preferred embodiment, the dust extraction and filtration system is a multi-stage extraction system including a first particulate filter with collection bag followed by a HEPA filter. The dust extraction and filtration system further preferably includes a hose connection fitting adapted for connection to a plurality of different tools, including hand-held tools with dust collection shrouds and/or ports.

In the preferred embodiment, the propane engine includes a catalytic muffler facilitating indoor use, and the electrical panel provides electrical power at different voltages or with different types of electrical outlets.

### BRIEF DESCRIPTION OF THE DRAWINGS

FIG. 1 is a first view of a preferred embodiment of the invention;

FIG. 2 is an opposing side view of the invention; and

FIG. 3 is an end view showing electrical outlets.

### DETAILED DESCRIPTION OF THE INVENTION

This invention improves upon the existing art by providing a mobile cart that provides both electrical power generation and dust collection. In the preferred embodiment, the dust collection incorporates HEPA filtration. The invention finds utility in many situations where electrically powered tools are used that create dust which must be collected and disposed of to reduce breathing hazards and/or in accordance with federal or local rules and regulations.

One such application is in concrete processing operations. Such operations may be performed in conjunction with concrete grinding or polishing but not necessarily. Other operations, such as coring, drilling, and sawing with hand tools also benefit from the invention whether or not grinding or polishing is performed. Indeed, the invention is not limited to concrete processing, as other operations that create unwanted dust with other materials would also benefit including wood, metal, drywall sanding, stone countertop cutting and finishing, and so forth.

The invention is particularly useful where power is not available and/or indoors, where a clean environment must be maintained whether power is available or not. For example, concrete processing is often performed in warehouses and “big-box” stores. In larger spaces, drop-down outlets may be available, but if the equipment used blows a breaker it can be a challenge to find and reset, wasting valuable time. In smaller rooms adjacent to larger floors, the use of conventional gas generators produce too much carbon monoxide and other harmful by products to be of any practical value.

The solution frequently adopted by work crews is the use of excessively long extension cords to reliable sources of power. This has obvious disadvantages, including the time required to unroll and retrieve the cords, disconnections, and damage, each of which can slow progress.

This invention solves the above problems and inconveniences with a mobile cart that provide two important functions; first, it provides reliable electrical power wherever it is needed; and second, it provides HEPA-filtered dust collection for any type of tool that generates dust, typically through a hose connection to the dust shrouds typically provided with such tools. Further, in the preferred embodiment, the cart is powered by a low-emission propane engine and catalytic muffler, thereby reduce harmful emissions of carbon monoxide (CO), oxides of nitrogen (NOx) and hydrocarbons (HCs).

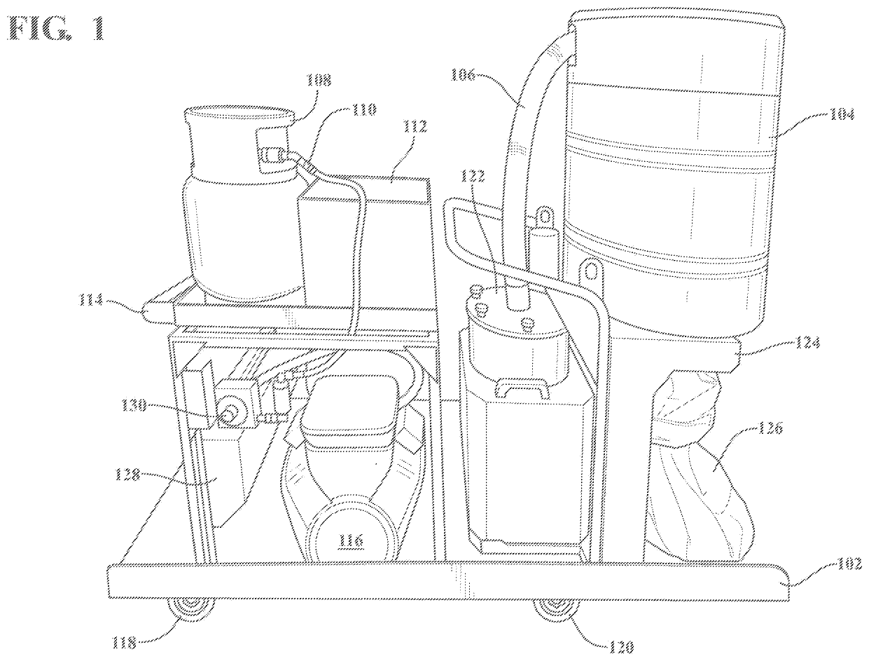

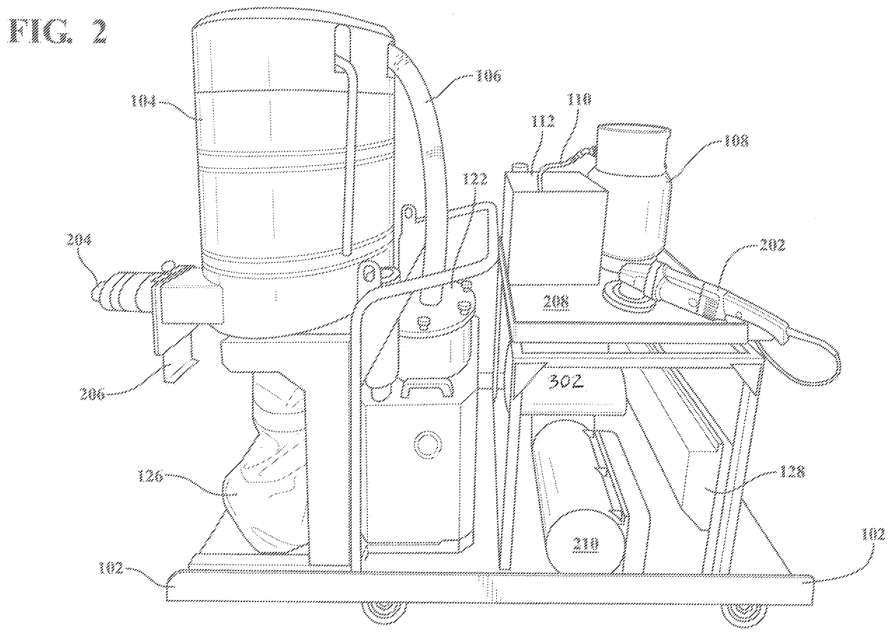

FIG. 1 is a first view of a preferred embodiment of the invention, and FIG. 2 is an opposing side view. The various components are mounted on a frame 102 supported by a plurality of wheels 118, 120 configured for floor contact. Some or all of the wheels may be pivotable and/or casters.

On frame 102 there are mounted subframes, including a shelf 208 to support propane canister(s) 108, miscellaneous tools such as angle grinder 202, and another platform 124 adapted to support vacuum filter housing 104. A handle 114 may be provided on either or both ends to push the cart to a desired location. The various frame components are preferably constructed of welded, painted steel. Propone tank 108 is ordinarily positioned in a tank holder 112, leaving space on the upper section of the cart for tool placement of a spare propane canister or other equipment.

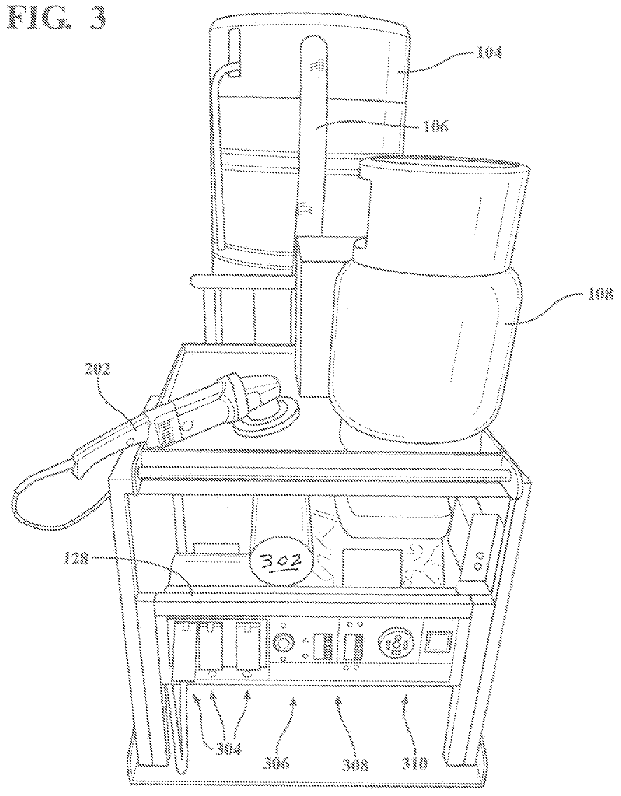

High-pressure propane line 110 feeds propane engine 116 through propane regulator 130. The engine in this case a two-cylinder, 627 cc, 26 hp Briggs & Stratton propane engine, though engines form different manufacturers and with different power ratings may potentially be used. Importantly, the engine should be a low-emission propane unit with sufficient power to operate generator 210 with respect to desired power requirements and, to further ensure low emissions, a catalytic muffler 302 is preferably used, as best seen in FIG. 3.

The dust extractor and containment subsystem preferably comprises a multi-stage collection and filtration assembly. Dust-producing tools and equipment connect via flexible hoses (not shown) to connector 204 shown in FIG. 2. Connector 204 is compatible with standard 2″ and 3″ hoses but the invention is not limited in this regard, as adapters may be provided for any diameters and indeed, manifolds may be provided to receive dust from multiple sources including hoses of differing diameters. Connection may be made to any tool through any appropriate shroud or output port(s) including shrouds for blades, drills, etc.

Connector 204 feeds vacuum filter housing 104, which extracts larger particulates from the airstream and deposits them into debris collection bag 126. Air diverter valve allows for the purging of filter 104 enabling debris to settle into bag 126 for appropriate disposal. Smaller particulates are delivered to a removable/replaceable HEPA filter disposed in housing 122.

The vacuum for dust collection is created by an electric motor plugged into electrical panel 128 powered by generator 210. This is a versatile arrangement insofar as if electrical power is available, the vacuum may be plugged into that source with the inventive cart unpowered. Alternatively, if only electrical power is required, the generator 210 may be left ON and the vacuum pump turned OFF.

FIG. 3 is an end view of the mobile combination cart showing electrical outlets. 120-V outlets are provided at 304, and 220 VAC outlets are provided at 306, 308. Item 310 is an hour meter and voltage/frequency output meter. The electrical panel 128 need not be configured as shown in FIG. 3. More or fewer outlets may be provided and at different voltage ratings. Indeed, while system described may be connected to certain grinders and polishers, with different generators 210, 1- and/or 3-phase electrical power may be provided to power larger grinders, polishers and other equipment. In the embodiment shown, generator 210 is a 12 kW unit. With appropriate engineering modification, higher-output generators may be accommodated, particularly if higher HP engines are used.

1. A combination cart providing independent electrical power and dust extraction, comprising:
a walk-behind mobile frame with a handle and wheels;
a propane engine and propane tank mounted on the frame;
an electrical generator mounted on the frame and powered by the propane engine;
wherein electrical energy provided by the electrical generator is delivered to an electrical outlet panel mounted on the frame;
a dust extraction and filtration system driven by an electric motor mounted on the frame; and
wherein the cart facilitates multiple modes of operation, including:
(a) dust extraction and filtration only, with the dust extraction system being powered by an available external source of electrical power;
(b) electrical power generation only, with the dust extraction and filtration system being turned off; and
(c) simultaneous dust extraction/filtration and electrical power generation, with the dust extraction and filtration system being powered by the electrical generator.

2. The combination cart of claim 1, wherein the propane engine includes a catalytic muffler facilitating indoor use.

3. The combination cart of claim 1, wherein dust extraction and filtration system is a multi-stage extraction system including a first particulate filter with collection bag followed by a HEPA filter.

4. The combination cart of claim 1, wherein dust extraction system includes a hose connection fitting adapted for connection to a plurality of different tools, including hand-held tools with dust collection shrouds and/or ports.

5. The combination cart of claim 1 wherein, in mode (c), the electric motor driving the dust extraction and filtration system is plugged into the electrical panel.

6. The combination cart of claim 1 wherein the electrical panel provides electrical power at different voltages or with different types of electrical outlets.
